(19) United States
(12) Patent Application Publication
(10) Pub. No.: US 2019/0337184 A1
(43) Pub. Date: Nov. 7, 2019

(54) MAGIC PERFECT MITRE

(71) Applicant: Magic Perfect Mitre LLC, Boynton Beach, FL (US)

(72) Inventors: Errol Hibbert, Boynton Beach, FL (US); Owen Dixon, Boynton Beach, FL (US)

(73) Assignee: Magic Perfect Mitre LLC

(21) Appl. No.: 16/400,176

(22) Filed: May 1, 2019

Related U.S. Application Data
(60) Provisional application No. 62/665,117, filed on May 1, 2018.

(51) Int. Cl. B27G 19/02; B23D 45/04; B23D 45/06; B23D 47/08; B23D 59/00

(52) U.S. Cl. CPC B27G 19/02; B23D 45/046; B23D 59/001; B23D 47/08; B23D 45/06

(57) ABSTRACT

A miter saw fixture including a base with at least two fixed angled guide rails secured to a top of the base, at least two track guides positioned on a bottom of the base, wherein the at least two track guides are adjustably secured to the base within a plurality of track openings, a blade track in the base, a front fence, and a back fence. A method of cutting an object using a miter saw fixture, including positioning the miter saw fixture on a miter saw using at least one guide track on the miter saw fixture, placing an object to be cut against at least one guide rail located a base of the miter saw fixture, sliding the miter saw fixture forward on the miter saw, cutting the object while the object is positioned in the miter saw fixture, and stopping the miter saw fixture.

### CROSS-REFERENCE TO RELATED APPLICATIONS

This patent application claims the benefit under 35 U.S.C. § 119(e) of U.S. Provisional Patent Application No. 62/665,117, filed May 1, 2018, which application is incorporated herein by reference

### FIELD OF THE INVENTION

The invention broadly relates to a miter saw fixture, more specifically to a miter saw fixture with preset guide rails, and even more particularly to a miter saw fixture with preset guide rails and track guides that slide in the tracks of the top of a miter saw.

### BACKGROUND OF THE INVENTION

Miter saws are use commonly used by craftsman to cut wood and other materials. Miter saws make accurate cuts in the work piece by moving the work piece through a mounted circular saw blade or, conversely, by moving the saw blade onto the work piece. A craftsman uses a miter saw in order to make quick and accurate cuts in a work piece at a selected angle. In this application, the work piece will be a wood material.

Miter saws are preferred to make cross cuts in wood. A cross cut is often a shorter cut that goes across, or perpendicular to, the grain of the wood. A rip cut is often a longer cut that runs along, or parallel to, the grain of the wood.

A miter saw fence is adjustable to make a wide array of angled cuts in a piece of wood. The fence includes specific angle increments, usually ranging a total of 180 degrees, for the craftsman to select a desired angle for the cut. At a jobsite, this is an attractive feature for craftsman as they often need to make angled cuts in a piece of wood. Craftsman commonly make angled cuts for framing and trim work, such as flooring and crown molding. The angles vary depending on where the piece of wood is being placed at the job site. Due to the varying angles of cuts needed, the angle between the saw blade and the fence changes frequently.

A disadvantage of constantly changing the cut angle on the miter saw is the reproducibility of making the same angled cut on the work piece. For example, a craftsman wants to make the frame for a kitchen cabinet door. The four sides of the frame will each have a positive 45 degree angle on one end and a negative 45 degree angle cut on the opposite end. The positive and negative angles are relative to a reference zero location.

The craftsman sets the first 45 degree angle, makes a series of cuts, and then reverses the fence angle to obtain the complementary second 45 degree angle cuts. When the craftsman resets the miter fence to the first 45 degree angle, it will not be in the exact same location. The fence may be slightly off 45 degrees, i.e. a few tenths of a degree if not more. While this inaccuracy may not impact certain type of cuts, like stud framing, accuracy is critical for kitchen cabinets.

Kitchen cabinetry requires fine craftsmanship to provide a clean product for the consumer. The spacing, or lack thereof, of the ends between cabinet door frames is an important aesthetic feature for kitchen cabinetry. The repeated movement of the miter fence creates spacing issues when the complementary 45 degree angled cuts are joined together. The desired result is a clean 45 degree miter joint with minimal to no spacing. When the miter fence is constantly set and reset, the slight variations in fence positioning creates spacing when the complimentary ends of a miter joint are paced together.

As can be derived from the variety of devices and methods directed at creating clean miter joints for kitchen cabinetry and other fine woodwork, many means have been contemplated to accomplish the desired end, i.e., an adjustable miter fence. Heretofore, tradeoffs between accuracy and reproducibility were required. Thus, there is a long-felt need for a device that provides reproducible angled cuts. There is a further long-felt need for a device that fits onto existing miter or table saws.

### BRIEF SUMMARY OF THE INVENTION

The present invention broadly comprises a miter saw fixture configured, to a miter saw, including a base with at least one angled guide rail and at least one track guide slidably engaged with a track in the top of a miter saw table.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of the miter fixture.

FIG. 2 is a top view of the miter fixture.

FIG. 3 is a bottom view of the miter fixture.

FIG. 4 is a top view of the miter fixture that includes a sample piece of wood that will be cut using the miter fixture.

FIG. 5 is a front view of the miter fixture.

FIG. 6 is a back view of the miter fixture.

FIG. 7 is a right view of the miter fixture.

FIG. 8 is a left view of the miter fixture.

FIG. 9 is a perspective view of the miter fixture positioned on a miter saw at the starting location prior to the cutting operation.

FIG. 10 is a perspective view of the miter fixture positioned on a miter saw at the finishing location after the cutting operation.

### DETAILED DESCRIPTION OF THE INVENTION

At the outset, it should be appreciated that like thawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “miter saw” is synonymous with terms such as “circular saw”, “chop saw”, “power saw”, “miter box”, etc., and such terms may be used interchangeably as appearing in the specification and claims. Although any methods, devices or materials similar or equivalent to those described herein can be used in the practice or testing of the invention, the preferred methods, devices, and materials are now described.

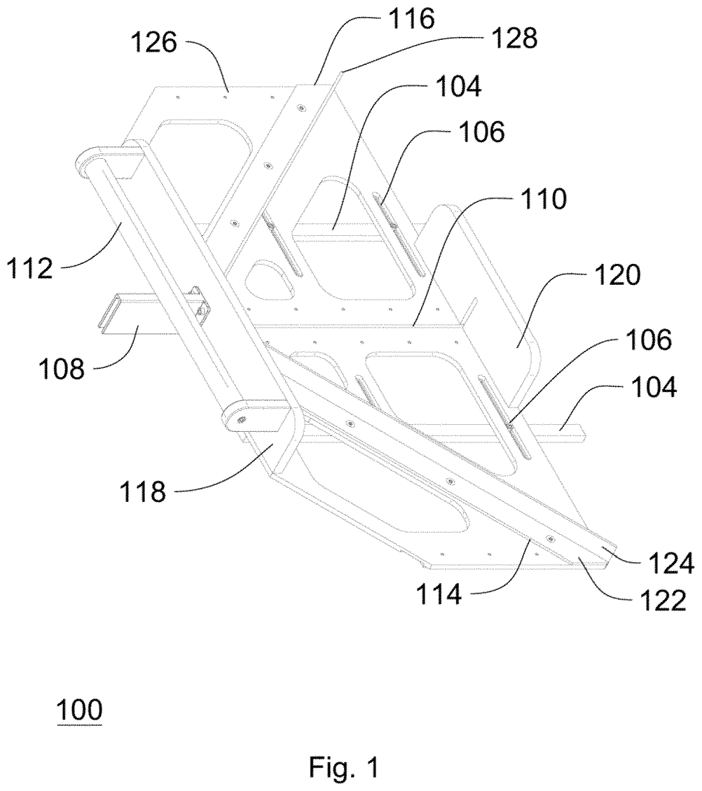

Adverting now to the figures, FIGS. 1-3 show a miter fixture 100 that fits on top of a standard miter saw. Base 102 of the miter fixture 100 sits on top of a miter saw, such as DEWALT or CRAFTSMAN, and slides forward and backward relative to the miter saw blade.

The bottom of base 102 includes two guide tracks 104 that are positioned in the tracks of the miter saw as a male/female connection. The male component being the guide tracks 104 and the female component being the recesses in the miter saw table top, i.e. the miter saw tracks. Standard miter saws include tracks on the table top that allow fences and other guides to be installed. The fences help secure object being cut using the miter saw in a set position to avoid movement of the object when the object is fed through the cutting blade of the miter saw.

The guide tracks 104 are adjustably secured to the bottom of base 102 through multiple guide track openings 106. The guide tracks 104 are rectangular in shape to complement the standard guide opening shape of miter saw table tops. As shown in FIGS. 1-3, there are three guide track openings 106 for each guide track 104. The three guide track openings 106 secure each guide track 104 into position on the miter saw track.

Guide tracks 104 are adjustable within guide track openings 106 to accommodate the different track locations on a miter saw table top, whether the miter saw is fixed or portable. The spacing of miter saw track locations, relative to the saw blade, vary for each original equipment manufacturer (OEM). The instant invention works on a wide array of miter saws by allowing the user to adjust the position of the guide tracks 104 relative to the OEM miter saw track locations.

To install the instant invention on the top of a miter saw, the user loosens the removable connection between the guide tracks 104 and guide track openings 106 of the base 102. The connection between the guide tracks 104 and the base 102 is any standard removable connection hardware, such as wing nuts, bolts, screws, Allen screws, etc. In an exemplary embodiment, the connection mechanism is recessed below the top of the base 102 within track openings 106 so the hardware does not interference with the movement of the wood (or work piece) that is housed within the top of base 102. In addition, the hardware should not extend past the bottom surface of the base 102 so the hardware does not interference with the flush mounting of the base 102 on the top of the miter saw.

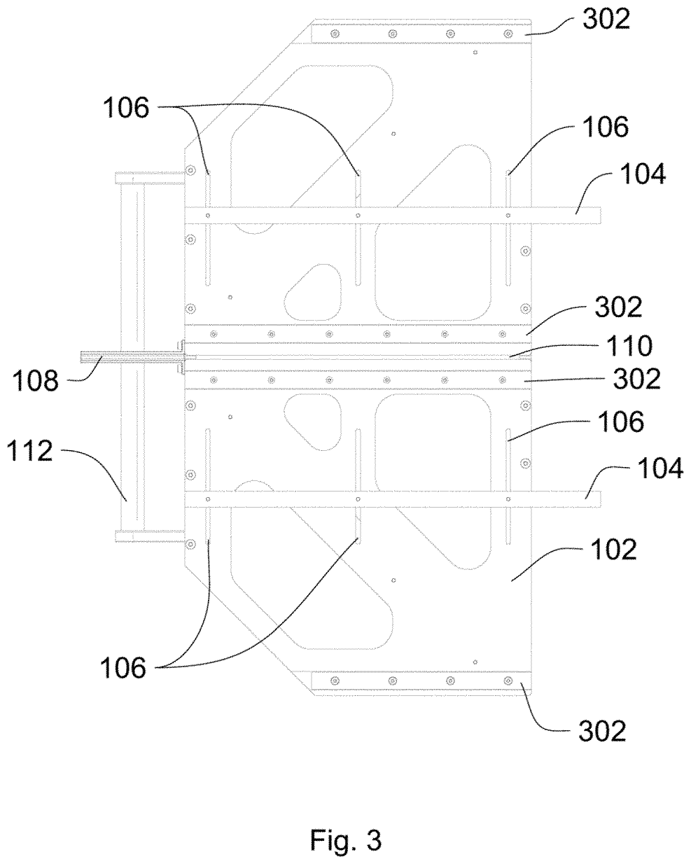

As shown in FIG. 3, the width and depth of the guide tracks 104 are designed to fit in the OEM miter saw tracks with enough clearance to allow the miter fixture 100, through guide tracks 104, to slide relative to the miter saw. The OEM miter saw tracks are designed for miter attachments to slidably engage with the tracks. Similar tolerances are used for the guide tracks 104 to allow for non-obstructed sliding engagement between the guide tracks 104 and OEM miter saw tracks. The miter fixture sides parallel to the axis of the miter saw cutting blade.

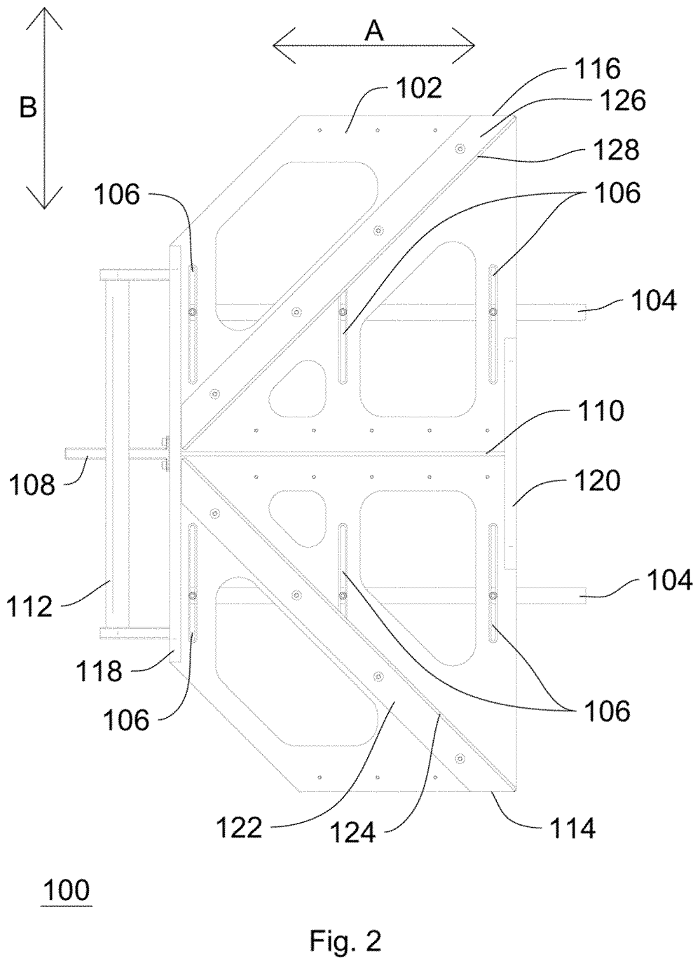

The path of the track openings 106 are substantially perpendicular to the position of the saw blade and guide tracks 104. This allows the user to adjust the span between the guide tracks 104 to allow the guide tracks 104 to adjust to the desired OEM miter saw tracks. As shown in FIG. 2, axis A is the direction of the blade guard, which the path of the miter saw blade 900. Guide tracks 104 adjust within track openings 106 in the direction of axis B, which is perpendicular to axis A.

In an exemplary embodiment, the bottom of base 102 also includes spacers 302. Spacers 302 provide a buffer between the bottom of the base and the top surface of the miter saw. Once the guide tracks 104 are engaged with the miter saw tracks, the spacers 302 attached to the bottom of base 102 contact and slide relative to the top of the miter saw. The height of spacers 302 from the bottom of base 102 provides a gap for any fasteners that are located on the bottom of base 102, for example the fasteners between front fence 118 and back fence 120 and the base 102, as shown in FIG. 3.

Once the miter fixture 100 and the guide tracks 104 are configured to be slidably engaged on top of the miter saw, the guide tracks 104 are fastened securely to base 102 so the miter fixture 100 and its components do not move when the miter fixture 100 is used for a cutting operation on the miter saw.

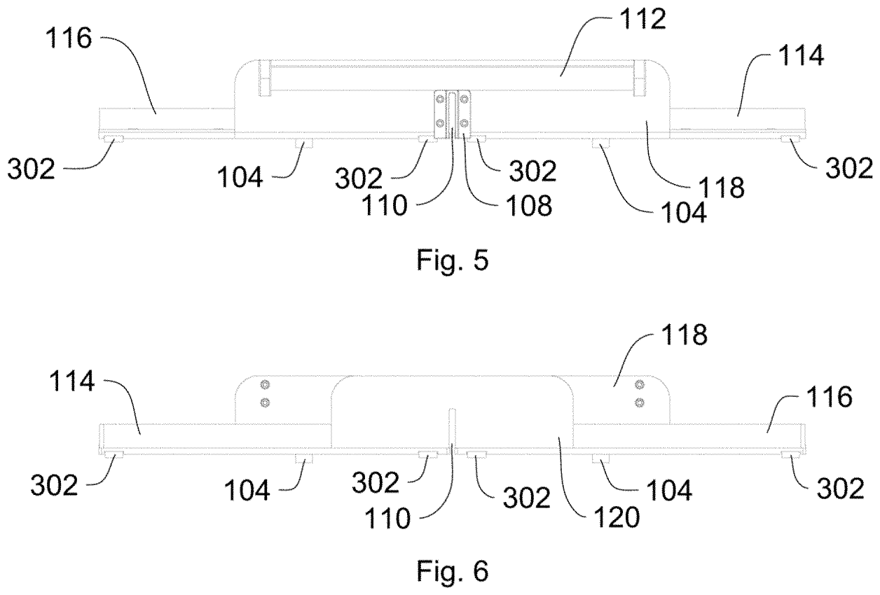

Base 102 also includes blade guard 108, blade track 110 and handle 112. When miter fixture 100 is set on top of a miter saw, the miter saw blade is positioned within blade track. 110. As shown in FIGS. 5 and 6, the blade track 110 is wide enough not to interfere with the miter saw black during start-up and the cutting operation. The blade track 110 spans the length of base 102, from the front fence 118 to the back fence 120.

Because the blade track 110 spans the length of base 102 to accommodate the miter saw blade during operating, base 102 has two portions, a left portion and a right portion. The front fence 118 and back fence 120 secure the left portion and the right portion of base 102 together to create a unitary miter fixture 100.

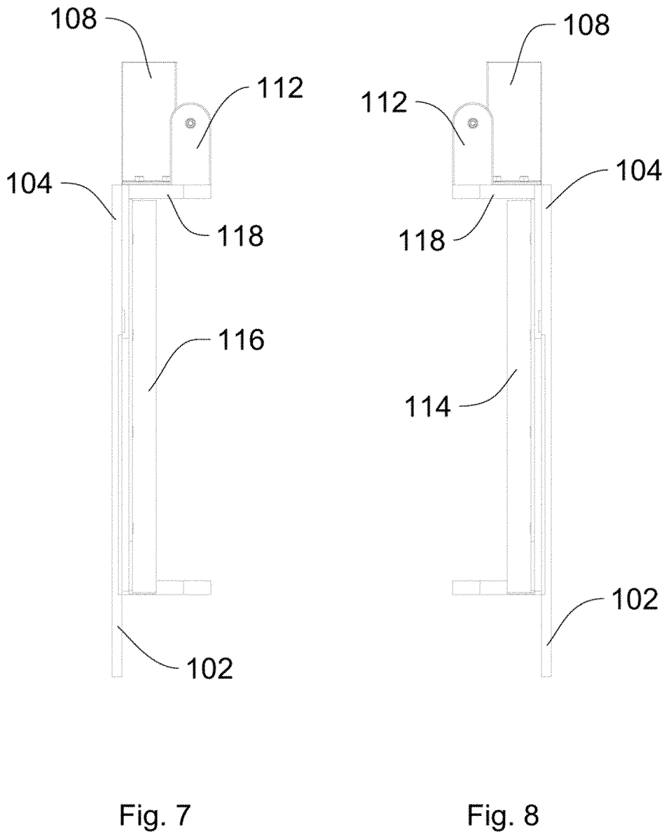

As shown in FIGS. 7 and 8, blade guard 108 is positioned on the front of the miter fixture 100, underneath or in close proximity to the handle 112, to protect the user's hand(s) and body during the cutting operation. When the user pushes the miter fixture 100 forward for a cutting operation, the user's hands and extremities comes in close proximity to the miter saw blade 900. Blade guard 108 creates a barrier between the saw miter saw blade 900 blade and the user's extremities to minimize the ability of the user's extremities coming in contact with the miter saw blade 900, which could cause severe damage to the user's body. The spacing within blade guard 108, similar to the blade track 110 spacing, accommodates the size of the miter saw blade 900.

In an exemplary embodiment, base 102 includes a stopper that limits the forward path of the miter fixture 100 on the top of the miter saw, which prevents the miter saw blade 900 from exiting the blade guard 108. This keeps the miter saw blade 900 contained and reduces the chance of a user being harmed by the miter saw blade 900.

The miter fixture 100 includes two guide rails, depicted in FIGS. 1 and 2. When standing in front of the miter fixture 100 where the user holds the handle 112, the first guide rail 114 is to the left of the user and second guide rail 116 is to the right of the user. The guide rails 114, 116 hold the wood in place during a cutting operation on the miter saw. First guide rail 114 is located on the left portion of base 102 and the second guide rail 116 is located on the right portion of base 102.

As shown in FIGS. 1 and 2, first guide rail 114 is complementary to second guide rail 116, meaning the orientation of the respective angles create a 90 degree joint. While a 90 degree joint/corner is the preferred embodiment, the guide rails 114, 116 can be configured to a wide array of miter joint angles. The length of the guide rails 114, 116 span the respective sides of base 102. This provides a fixed fence vertical wall to position an object 400 against when making a desired angled cut. While one end of an object 400 is capable of extending past the edge of the miter fixture 100 and guide rails 114, 116, i.e. the end away from the miter saw blade 900, most cabinetry parts will fit within the length of the guide rails 114, 116 to provide maximum support and stability of the object 400, e.g. wood, in the miter fixture 100.

First guide rail 14 and second guide rail 116 are positioned against the front fence 118. First guide rail 114 includes first guide rail support 122 and first guide rail fence 124. Second guide rail 116 includes second guide rail support 126 and second guide rail fence 128. The guide rail supports 122, 126 are secured to base 102. In one embodiment of the present invention, the guide rail supports 122, 126 are fixed relative to base 102. In another embodiment of the present invention, the guide rail supports 122, 126 are adjustable relative to base 102 to provide for different angled cuts of object 400. Guide rail fences 124, 128 extend vertically up from the base 102 and are used to secure the object 400 within the miter fixture 100.

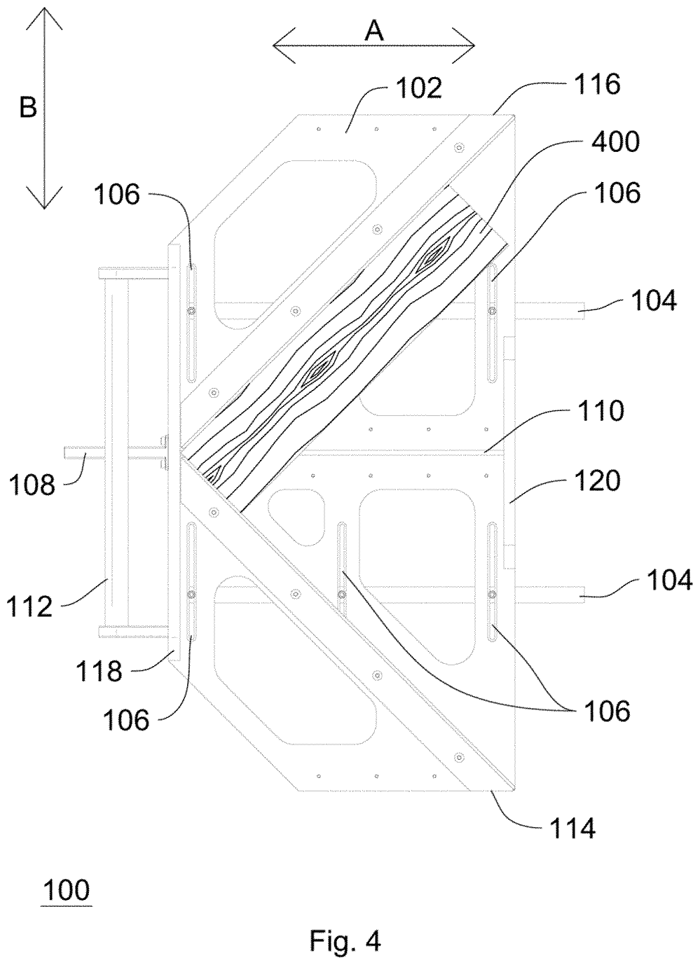

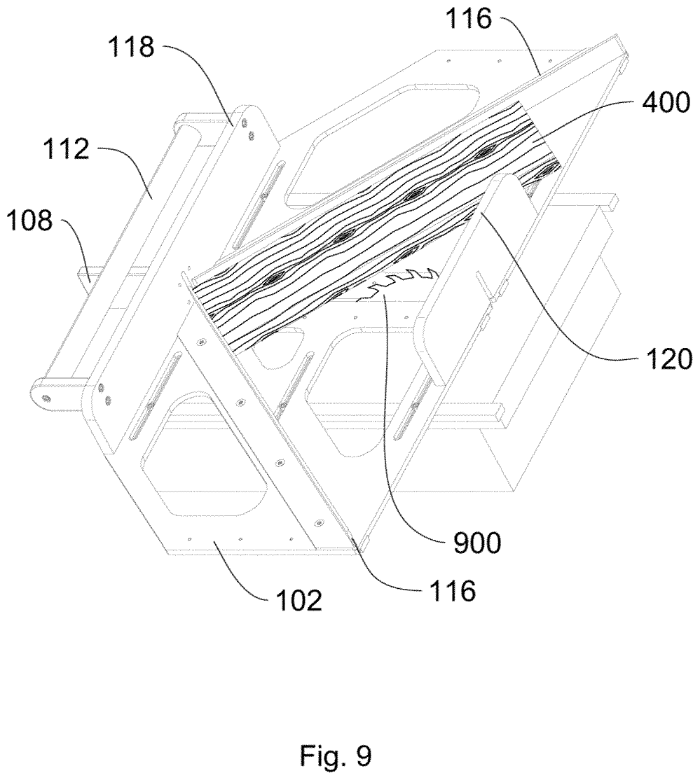

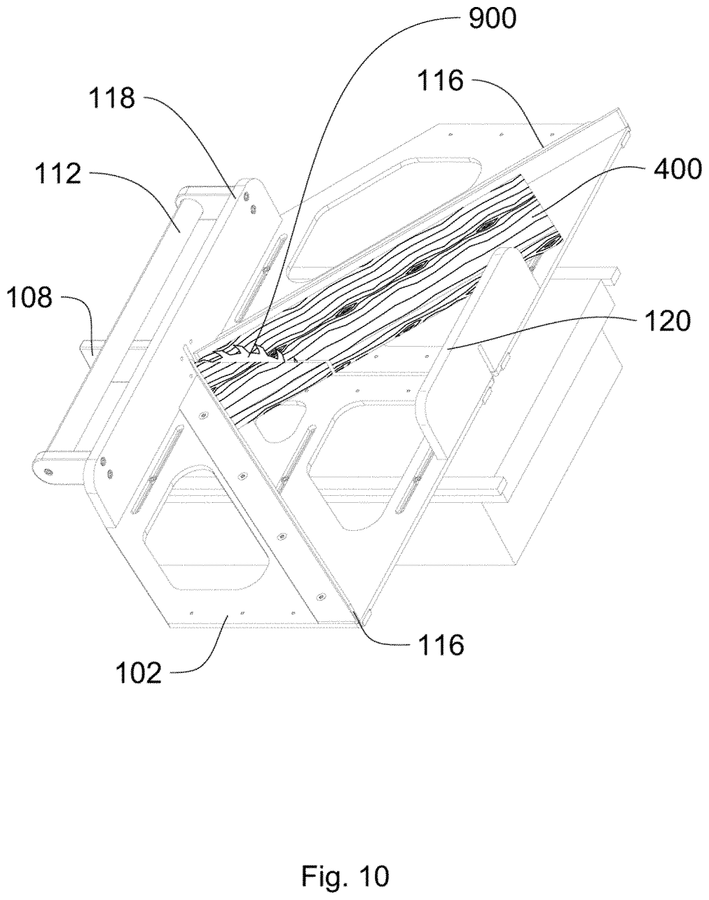

To use the miter fixture 100 with the miter saw, the user positions the miter fixture 100 on top of the miter saw with the miter saw blade 900 in blade track 110, near the back fence 120, i.e. the start position (See FIGS. 9 and 10). As shown in FIG. 4, the user places an object 400 to be cut against the guide rails 114, 116. In an exemplary embodiment, object 400 is a piece of wood. One side of the object 400 is positioned flush against the first guide rail fence 124 and the adjacent side of the object 400 is positioned flush against the second guide rail fence 128. The object is positioned in the guide rails 114, 116 near the front fence 118. In an exemplary embodiment, the object 400, when positioned against guide rails 114, 116, is secured to the miter fixture 100 vertically with an additional clamp.

The cutting operation beings by a user holding the miter fixture 100 using handle 112, which is connected to front fence 118. Once the user confirms that the saw blade is not in contact with any materials, i.e. the object or blade track 110, the user turns the miter saw on, thereby initializing the rotation of the miter saw blade 900. Once the miter saw blade 900 is up to the desired rotational speed (RPM), the user places at least one hand on the handle 112. The user then exerts a forward force on handle 112 to slide the miter fixture 100 forward on the miter saw. The miter fixture 100 slides relative to the miter saw using guide tracks 104 and the miter saw tracks.

As the miter fixture 100 is slid forward on the miter saw, the miter saw blade travels through the blade track 110 and eventually comes in contact with the object 400. When the miter saw blade 900 comes into contact with the object 400, the object 400 is constrained by guide rail fences 124, 128. The object 400 may also be constrained vertically relative to base 102. The user continues pushing the miter fixture forward until the miter saw blade 900 fully cuts the object 400. As the user continues to push the miter fixture 900 on the miter saw, the miter saw blade 900 cuts the object 400 into two pieces and continues through the front fence 118 and into the blade guard 108. At that point, the saw blade will be partially or fully positioned within blade guard 108. When the cutting operation is complete, either during rotation of the miter saw blade 900 or after rotation is terminated, the user pulls the miter fixture back to the start position using handle 112. Then the miter saw is turned to an off position

When the cutting operation is complete, the wood has a clean, angled cut on one end. For multiple cuts, the user can chose to do all the desired angle cuts on first guide rail 114 (e.g. positive 45 degrees) and then switch to the desired angled cuts on the second guide rail 116 (negative 45 degrees). Alternatively, the user can cut a piece of wood using first guide rail 114 and then immediately cut a piece of wood on second guide rail 116. Because guide rails 114, 116 are secured to miter fixture 100 and are not adjustable, each cut is accurate and reproducible.

In an exemplary embodiment of the invention, the guide rails 114, 116 are positioned on base 102 at a 90 degree angle relative to each other. By securely fixing the guide rails 114, 116 at 90 degrees, the object 400 being cut will be split into two pieces, each having a 45 degree angle. In an exemplary embodiment where the guide rails 114, 116 are fixed relative to base 102, there is no movement between the guide rails 114, 116 relative to each other.

In an exemplary embodiment, the guide rails 114, 116 are moved to other fixed angled locations based on common angle cuts, such as 45/45, 30/60, and other common end joint angles. To reduce the variation in cuts during the cutting operation, the guide rails 114, 116 are fixed relative to the miter fixture 100 and are moved and re-secured when necessary.

When there is adjustability involved, the angle between guide rails 114, 116 may vary slightly, for example a half-degree (0.5 degrees). Every time there is a cutting operation, the force of object 401) being pushed through the miter saw blade 900 will cause variation within a standard adjustable miter saw fence. The user set angle may move during the cutting operation. This is especially true when cutting harder or dense wood objects. Moreover, any clamp used to hold the object relative to the fence may become loose during the cutting operation and inadvertently alter the cutting angle and resulting miter joint. While this may be a small angle, this variation between cuts of a piece of wood can significantly alter the 45-degree miter cuts for a 90 degree joint between two mating objects, such as in kitchen cabinet doors. While an exemplary embodiment of the present invention has adjustable guide rails 114, 116, the preferred embodiment has fixed guide rails 114, 116 relative to base 102.

Typical miter saws include adjustable positions to angle the object 400 to be cut relative to the miter saw blade 900, or vice versa. However, these constant adjustments and repositioning of the miter saw and its equipment reduce the ability to cut precise angled cuts with the miter saw that form tight miter joints. Tight miter joints are defined as angle cuts that leave little to no space between the joints when the two ends are joined together, typically two 45 degree cuts that produce a 90 degree angle. For example, a non-tight miter joint would include two miter cuts that result in an 89 or 91 degree joint.

For example, in a standard 45 degree miter joint, one end of a piece of wood is cut at a positive 45 degree angle and a second end of a piece of wood is cut at a negative 45 degree angle. The angle is measured from a fixed reference point, e.g. the miter saw blade 900 axis. When the user connects the two ends (positive and negative 45-degree angled cuts), the result is a 90 degree corner joint. This is a common joint for kitchen cabinetry.

When the user must continually adjust the positioning of the miter saw to make varied angled cuts, e.g. positive and negative 45 degrees, inaccuracy results when the miter saw fence (or other means to move the cutting angle of the saw blade) is changed. Even if the miter saw is repositioned at the same angle, the movement alone will result in less accurate angled cuts. While these variations seem minor, the imprecision creates a space between the two ends of a miter joint. In some applications, such as baseboard joints, this spacing is not critical as gaps are filled with caulking. However, for high-end cabinetry the miter joints should be tight with little to no spacing.

In an exemplary embodiment, a clamp is installed on the miter fixture 100, in one embodiment on one or both of the guide rails 114, 116, to secure the object 400 in a vertical direction to the base 102. A wide variety of standard clamps can be selected to connect the miter fixture 100 to secure the object 400 in position within the miter fixture 100. Example of clamps include, but are not limited to, hold down, toggle, and lever clamps. The clamps are secured either to the guide rail 114, 116 or on the miter fixture 100 on the opposite side of the guide rail 114, 116 when the wood is in position.

The object 400 is constrained horizontally by the guide rail fences 124, 128. By constraining, the object 400 relative to the guide rails 114, 116, without or without the vertical clamp, use of the miter fixture 100 on a miter saw produces a repeatable angled cut of the object preferably 90 degrees.

One of the objectives of the present invention is to allow a user to cut all pieces of wood for kitchen cabinetry with tight end joints. In a typical kitchen, there are ten cabinet doors. Each cabinet door has four sides and four end joints. For a standard 90 degree joint with 45 degree sides, each end of the side is cut with a 45 degree angle. In total, for ten cabinets, a user must make eighty 45 degree cuts, forty in at a positive 45 degree angle and forty at a negative 45 degree angle relative to a fixed reference point.

To create tight miter joints, the craftsman (user) needs to make reproducible angled cuts on the miter saw. Each angled cut should be exactly the same, with no variation based on the positioning of cut angle. This will allow each cut to be uniform and create consistent and reproducible cuts that create tight miter joints.

While wood is referenced herein as the example of object 400, other construction materials can be cut using the miter fixture 100. Examples include, but are not limited to, medium density fiber board (MDF), medium density overlay (MDO) panels, Masonite, and plastic composite molding. In addition, while kitchen cabinets are used as an example of the type of project requiring tight miter joints, other examples include crown molding, pictures frames, and other finish carpentry.

In an exemplary embodiment, the miter fixture 100 is set up to make compound angle cuts. Compound angle cuts are when two angles are cm on a piece of wood. For instance, the wood is set on first guide rail 114, which is set at a 45 degree angle relative to the miter saw blade 900, and the miter saw blade 900 itself is reoriented from the normal 90 degree vertical position relative to the top surface of the miter fixture 100 (or miter saw top). To accomplish a compound angle cut, the miter fixture 100 is modified to create more space for the saw blade angle in the front fence 118, back fence 120, blade guard 108, and blade track 110. Another exemplary embodiment is to make the blade guard 108 rotatable to correspond to the miter saw blade 900 angle.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A miter saw fixture, comprising:
a base with at least two fixed angled guide rails secured to a top of the base;
at least two track guides positioned on a bottom of the base, wherein the at least track guides are adjustably secured to the base within a plurality of track openings;
a blade track in the base;
a front fence; and
a back fence.

2. The miter saw fixture recited in claim 1, wherein an object is positioned to contact the at least two fixed angled guide rails.

3. The miter saw fixture recited in claim 2, further comprising a clamp to secure the object on the base.

4. The miter saw fixture recited in claim 1, wherein a first side of an object is positioned against a first guide rail fence and an adjacent side of an object is positioned against a second guide rail fence.

5. The miter saw fixture recited in claim 1, further comprising a handle connected to the front fence.

6. The miter saw fixture recited in claim 1, further comprising a blade guard.

7. The miter saw fixture recited in claim 1, wherein a first guide rail is secured on the base at a 90 degree angle relative to a second guide rail secured on the base.

8. A miter saw fixture slidably engaged with a miter saw, comprising:
a base;
a first guide rail and a second guide rail, both fixedly secured to a top of the base;
at least two track guides positioned on a bottom of the base, wherein the at least two track guides are adjustably secured to the base within at least two track openings; and
a blade track that spans the entire length of the base, separating the base into two base portions, wherein the two base portions are connected using a front fence and a back fence.

9. The miter saw fixture recited in claim 8, wherein an object is positioned to contact the first guide rail and the second guide rail.

10. The miter saw fixture recited in claim 9, further comprising a clamp to secure the object on the base.

11. The miter saw fixture recited in claim 8, wherein a first side of an object is positioned against a first guide rail fence and an adjacent side of an object is positioned against a second guide rail fence.

12. The miter saw fixture recited in claim 8, further comprising a handle connected to the front fence.

13. The miter saw fixture recited in claim 8, further comprising a blade guard.

14. The miter saw fixture recited in claim 8, wherein the first guide rail is secured on the base at a 90 degree angle relative to the second guide rail secured on the base.

15. A method of cutting an object using a miter saw fixture, comprising:
positioning the miter saw fixture on a miter saw using at least one guide track on the miter saw fixture;
placing an object to be cut against at least one guide rail located a base of the miter saw fixture;
sliding the miter saw fixture forward on the miter saw;
cutting the object while the object is positioned in the miter saw fixture; and
stopping the miter saw fixture.

16. The method of cutting an object using the miter saw as recited in claim 15, wherein the at least one guide track is adjustable through the fasteners connecting the at least one guide track to a plurality of track openings.

17. The method of cutting an object using the miter saw as recited in claim 15, wherein a first guide rail and a second guide rail form a 90 degree angle.

18. The method of cutting an object using the miter saw as recited in claim 15, wherein the miter saw fixture slides forward using a handle.

19. The method of cutting an object using the miter saw as recited in claim 15, wherein the object is cut using a miter saw blade that travels through a blade track of the miter saw fixture.
